(19) United States
(12) Patent Application Publication
(10) Pub. No.: US 2019/0065021 A1
(43) Pub. Date: Feb. 28, 2019

(54) HYBRID SCROLLING OF USER INTERFACES

(71) Applicant: Google Inc., Mountain View, CA (US)

(72) Inventors: Michael Alexander Digman, Mountain View, CA (US); Jia Wei Tam, Seattle, WA (US)

(21) Appl. No.: 15/691,192

(22) Filed: Aug. 30, 2017

(51) Int. Cl. G06F 3/0485; G06F 3/0483; B60K 35/00

(52) U.S. Cl. CPC G06F 3/0485; G06F 3/0482; B60K 35/00; G06F 3/0483

(57) ABSTRACT

Methods, systems, and apparatuses, including computer programs encoded on a computer-readable storage medium for implementing hybrid scrolling are described. In some implementations, when a user input is received to browse through information, such as a list of content, a control processor may determine whether the user input satisfies one or more of a velocity threshold and a distance threshold. If either the velocity threshold or the distance threshold is satisfied, the control processor can perform a page transition to cause a preceding or succeeding page of information to be displayed. If neither the velocity threshold nor the distance threshold is satisfied, the control processor scrolls through the information according to a distance and direction corresponding to the distance and direction associated with the user input.

### FIELD

This disclosure generally relates to graphical user interfaces.

### BACKGROUND

Graphical user interfaces (GUIs) are prominently used with display devices to display information to users. Because the amount of information often exceeds the display size, various display techniques, such as scrolling, are used to display information. However, existing techniques to navigate user interfaces may be difficult or inconvenient for users to browse at times. Such difficulties or inconveniences can become amplified when the user is in a particular environment, such as when the user is in a vehicle.

### SUMMARY

Aspects and implementations described in this specification relate to hybrid scrolling. For example, a system can respond to user gestures of a certain type, such as vertical movements along a touchscreen, with different responses based on properties of the gesture. In this manner, a user can initiate incremental scrolling of the user interface or a page transition with a vertical movement. When a user input is received to browse through information, such as a list of content, being displayed, a control processor may determine whether the user input satisfies one or more of a velocity threshold and a distance threshold. If the velocity threshold, the distance threshold, or both are satisfied, the control processor executes a page transition command and a preceding or succeeding page of information is displayed. If neither the velocity threshold nor the distance threshold is satisfied, the control processor executes a scrolling command and scrolls through the information according to a distance and direction associated with the user input.

The techniques for hybrid scrolling discussed herein are applicable for navigating content that is organized into pages, as well as content that is not organized into predetermined pages. For example, when a list of items is shown, the set of list items fully viewable on the user interface can represent a current view or “page.” The set of content representing the previous page or next page can be dynamically determined with respect to the current view. For the current view shown in the user interface, the system can determine anchor points along the list or other scrollable content, and can identify anchors that represent the next and previous views that would fully change the set of viewable content shown on the user interface. For example, if a user interface can fit five items in a display area, and the user is currently viewing items 7-11, the system can dynamically set anchor points in the content so that a page up command causes the system to show items 2-6 and a page down command causes the system to show items 12-17. The system can take into account varying sizes of list items and other factors to set or select anchor positions representing earlier or later pages of content.

Aspects and implementations described in this specification may offer several advantages. One advantage is that the system offers increased precision for controlling navigation of the user interface. The option to specify incremental scrolling or a page transition can significantly improve control over the movement and display of information. By utilizing velocity and distance thresholds, information is prevented from moving in a random and unpredictable manner. For example, when a touch and drag input is received from a user for a distance that is greater than a distance threshold, displayed information transitions to the next page of information and does not scroll for an unpredictable or unknown amount of time or length. In another example, when a touch and drag input is input at a velocity that is greater than a velocity threshold, displayed information transitions to the next page of information and does not scroll for an unpredictable or unknown amount of time or length. In this manner, the user is unlikely to miss information if the user cannot maintain visual contact with the display screen. This is particular advantageous in several environments including, for example, when the user is a driver of a vehicle because drivers cannot sustain visual contact with a display screen for too long.

Utilizing minimum velocity and distance thresholds is also advantageous to guard against unintentional or accidental inputs. For example, if a small touch and drag user input that is less than a minimum distance threshold is detected, the system may determine that the input was unintentional or accidental and may ignore the user input.

The technique of allowing incremental scrolling and page transitions to display information is advantageous because a user may browse through information without looking at a display screen if the user desires to view a preceding or succeeding page of information on the display screen.

In general, innovative aspects of the subject matter described in this specification can be embodied in a computer-implemented method that includes one or more computer devices controlling a display device to display a first portion of a list on a graphical user interface, receiving a user input to the one or more computing devices, determining that the user input satisfies at least a distance threshold or a velocity threshold, and determining that the user input corresponds to a page transition command based on determining that the user input satisfies at least the distance threshold or the velocity threshold. In response to determining that the user input corresponds to the page transition command, the one or more computing devices control the display device to display a second portion of the list such that (i) list items fully viewable in the first portion of the list are not shown on the graphical user interface, and (ii) list items ordered immediately before or immediately after the first portion of the list are shown on the graphical user interface.

Implementations may each optionally include one or more of the following features. For instance, in some implementations, determining that the user input corresponds to the page transition command includes selecting between (i) classifying the user input as an incremental scroll command, and (ii) classifying the user input as a page transition command. The selection is made based on whether the user input satisfies at least the distance threshold or the velocity threshold.

In some implementations, the second portion corresponds to a page immediately following the first portion of the list or a page immediately preceding the first portion of the list when the user input corresponds to a page transition command. The display device is configured to display a page on a single screen of the display device.

In some implementations, the computer-implemented method further includes receiving a second user input, determining that the second user input does not satisfy the distance threshold and does not satisfy the velocity threshold, and determining that the second user input corresponds to a scrolling command that does not involve a page transition in response to determining that the user input does not satisfy the distance threshold and does not satisfy the velocity threshold.

In some implementations, the computer-implemented method further includes determining an anchor position in the list corresponding to a particular item in the list that immediately follows a last list item that is fully viewable in the first portion of the list, and determining that the user input requests a portion of the list after the first portion of the list. The operation of controlling the display device to display the second portion of the list includes controlling the display device to display a portion of the list that begins at the determined anchor position, and controlling the display device to display the particular item in the list at the beginning of the displayed portion of the list that begins at the determined anchor position.

In some implementations, the computer-implemented method further includes determining an anchor position in the list corresponding to a particular item in the list that occurs immediately before the list items in the first portion of the list. The particular item is selected such that when the particular item is the first list item shown in a list view area of the user interface, a list item fully viewable in the list view area is a list item that occurs immediately before the first list item fully viewable in the first portion of the list. The method further includes determining that the user input requests a portion of the list before the first portion of the list. The operation of controlling the display device to display the second portion of the list includes controlling the display device to display a portion of the list that begins at the determined anchor position, and controlling the display device to display the particular item in the list at the beginning of the displayed portion of the list that begins at the determined anchor position.

In some implementations, two or more items in the list have different sizes. Views of different portions of the list shown in response to page transitions commands include different numbers of list items.

In some implementations, the computer-implemented method further includes determining, by the one or more computing devices: a position of a first anchor that corresponds to (I) a position on the list that immediately precedes the first portion of the list being displayed by the display device, and (II) a portion of the list immediately preceding the first portion of the list being displayed by the display device; and a position of a second anchor that corresponds to (I) a position on the list that immediately follows the first portion of the list being displayed by the display device, and (II) a portion of the list immediately following the first portion of the list being displayed by the display device. The operation of controlling the display device to display the second portion of the list includes controlling the display device to display a view of the list using the first anchor or the second anchor.

In some implementations, the computer-implemented method further includes determining, by the one or more computing devices: a modified position of the first anchor that corresponds to (I) a position on the list that immediately precedes the second portion of the list being displayed by the display device, and (II) a portion of the list immediately preceding the second portion of the list; and a modified position of the second anchor that corresponds to (I) a position on the list that immediately follows the second portion of the list being displayed by the display device, and (II) a portion of the list immediately following the second portion of the list.

In some implementations, the computer-implemented method further includes determining an order for the items in the list, determining a size of graphical representations of the items in the list, determining, based on the order for the items and the size of the graphical representations, a set of the graphical representations that configure a page immediately preceding the first portion of the list displayed on the display device before receiving the user input, and setting an anchor position in the list corresponding to a boundary of the page immediately preceding the first portion.

In some implementations, determining a position of the second anchor includes determining an order for the items on the list, determining a size of the graphical representations of the items in the list, determining, based on the order for the items and the size of the graphical representations, a set of the graphical representations that configure a page immediately following the first portion of the list displayed on the display device before receiving the user input, and setting an anchor position in the list corresponding to a boundary of the page immediately following the first portion.

In some implementations, graphical representations for the items in the list each have a same size.

In some implementations, the display device is a display device in a vehicle. The computer-implemented method further includes obtaining the list to be displayed through the display device in the vehicle using the graphical user interface, organizing the list into pages based on a size of the display device in the vehicle, and determining, by the one or more computing devices, one or more anchors to be applied to the list, each of the one or more anchors respectively corresponding to (i) a position on the list, and (ii) a particular page.

In some implementations, organizing the list into pages includes determining an order for the data content items on the list, determining a size of graphical representations for each list item in the list, and determining a number of graphical representations of the list items per page.

In some implementations, the computer-implemented method further includes determining that additional list items are to be added to the list, determining a position in the list where the additional list items are to be added based on an order of items in the list, adjusting the list to add the additional list items to the list at the determined position, and determining, based on the adjusted list, positions of (i) a first anchor corresponding to a page immediately preceding the first portion of the list, and (ii) a second anchor corresponding to a page immediately following the first portion of the list.

In some implementations, determining, by the one or more computing devices, whether the user input satisfies at least a distance threshold or a velocity threshold includes: a) determining whether the user input satisfies the distance threshold and determining whether the user input satisfies the velocity threshold in response to determining that the user input does not satisfy the distance threshold, or (b) determining whether the user input satisfies the velocity threshold and determining whether the user input satisfies the distance threshold in response to determining that the user input does not satisfy the velocity threshold.

In some implementations, controlling the display device to display the second portion of the list includes searching for a second anchor that immediately precedes or follows a first anchor associated with the first portion of the list, and obtaining a page of the list associated with the second anchor.

Other implementations of these aspects include corresponding systems, apparatus, computer-readable storage mediums, and computer programs configured to implement the actions of the above-noted methods.

The details of one or more implementations are set forth in the accompanying drawings and the description below. Other features and advantages will become apparent from the description, the drawings, and the claims.

### BRIEF DESCRIPTION OF THE DRAWINGS

FIG. 1A depicts an exemplary system in which a device implementing hybrid scrolling operates.

FIG. 1B depicts an exemplary view of visible and non-visible areas of a list displayed on a device.

FIG. 2A depicts an exemplary scenario in which a page transition command is executed as a result of a large vertical displacement input.

FIG. 2B depicts an exemplary scenario in which a scrolling command is executed as a result of a small vertical displacement input.

FIG. 2C depicts an exemplary scenario in which a page transition command is executed as a result of a large velocity input.

FIG. 2D depicts an exemplary scenario in which a page transition command is executed as a result of a button input.

FIG. 2E depicts an exemplary scenario in which a scrolling command is executed as a result of a button input.

FIG. 3 depicts a flowchart illustrating exemplary methods for hybrid scrolling.

FIG. 4 depicts a flowchart illustrating exemplary methods for inputting new data content.

Like reference numbers and designations in the various drawings indicate like elements.

### DETAILED DESCRIPTION

Vehicles often include displays to provide information to a driver or passengers in the vehicle. Because vehicle displays have a limited size and may not be able to display all the content in an interface, a driver may want to scroll or otherwise view information not currently displayed. For example, in a list of information, a user may request the vehicle to provide information that is not being displayed on a screen of the vehicle display for example, by navigating to other portions the list of information. If the user is a driver, it may be challenging for the driver to precisely navigate through the list of information on the screen while driving the vehicle. For example, because the driver has a limited amount of time to view the screen, the driver may rush inputs resulting in undesirable browsing through the list of information and a frustrating and inconvenient user experience. Additionally, in some cases, the driver may input a command to scroll through the information list and subsequently redirect attention to the road. As a result of redirecting attention to the road, the driver may miss or not view one or more list items that appeared briefly on the display screen.

Implementations described herein provide methods and systems for hybrid scrolling that facilitate improved control and precision for user interface navigation. Exemplary implementations are described with reference to the figures.

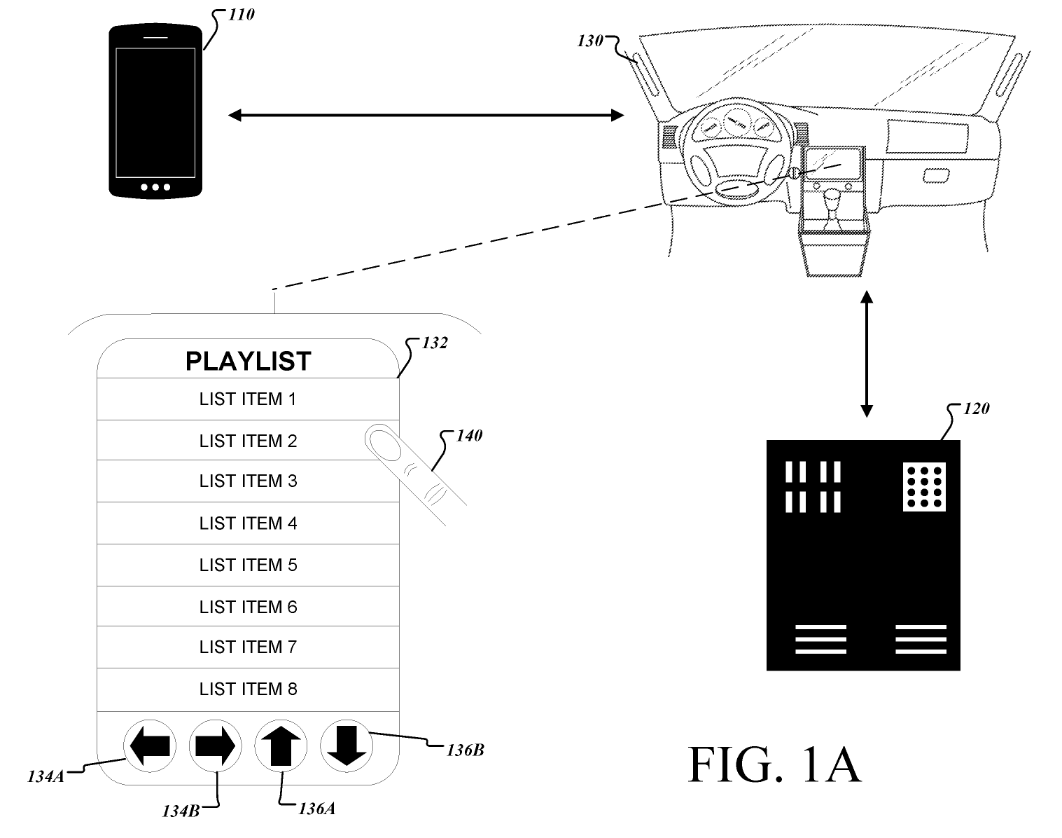

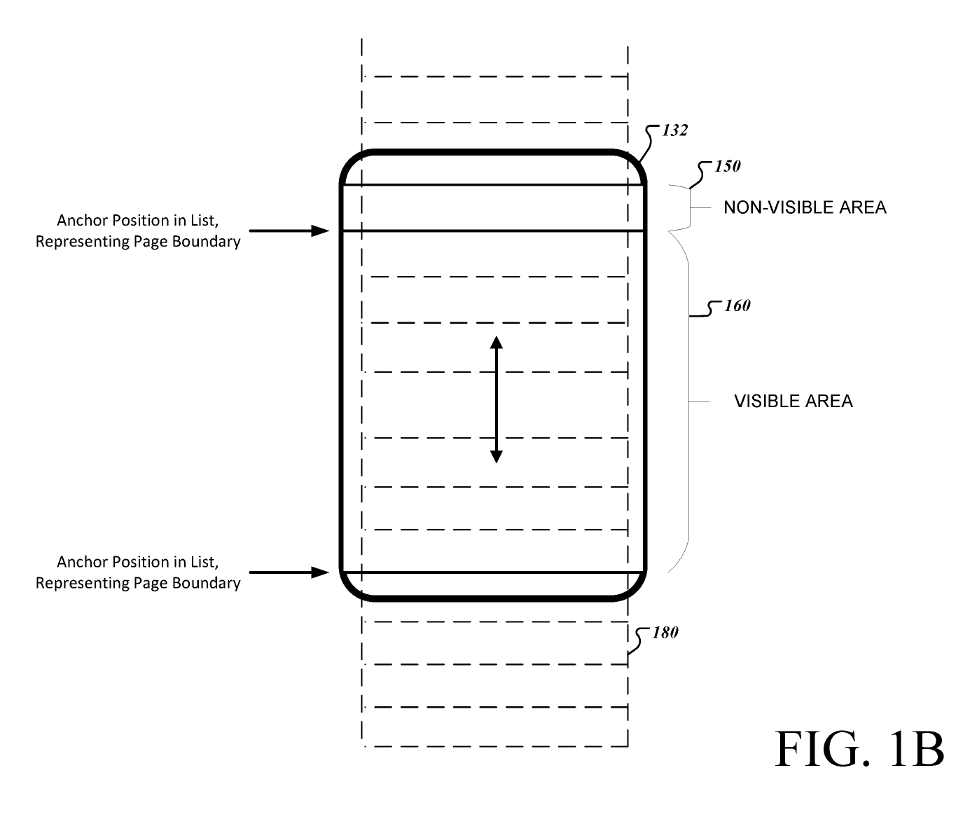

FIG. 1 depicts an exemplary system in which a device implementing a hybrid scrolling method operates. The system includes a electronic device 110, one or more servers 120, and a vehicle 130. The vehicle 130 includes a display device having a screen 132 that displays content. Buttons 134A, 134B, 136A, and 136B may be used to interface with the display device.

In some implementations, a user can use a gesture along a touch screen to initiate a transition between different pages or views, instead of using buttons. This gesture can be the same type of gesture used for scrolling of the interface, e.g., a swipe or slide of a finger. For example, a user can initiate incremental scrolling or a page transition depending on the motion characteristics of movement along a touch screen. The electronic device 110 can evaluate characteristics of user input, for example, by determining whether the user input satisfies distance or velocity thresholds. For example, the electronic device 110 can interpret motions that have at least a minimum distance or velocity to represent page transition commands, while motions that do not satisfy the thresholds are interpreted as scroll commands. Thus, the user can varying the distance and/or velocity of the movement to specify whether an incremental scroll or a page transition should be performed.

The electronic device 110 may be any suitable electronic device including, but not limited to, a computer, lap top, personal digital assistant, electronic pad, electronic notebook, telephone, smart phone, television, smart television, a watch, navigation device, or, in general, any electronic device that can connect to a network and interface with a user. The electronic device 110 may be any combination of hardware and software and may execute any suitable operating system such as an Android® operating system. The electronic device 110 may be separate from and removable from the vehicle 130 as illustrated, or the electronic device 110 may be integrated with the vehicle 130, such as an in-dash navigation system, an infotainment system, etc.

The electronic device 110 may communicate with one or more servers 120 and a vehicle control module in vehicle 130. For example, the electronic device 110 may communicate with the vehicle control module in vehicle 130 to execute one or more vehicle operations such as, for example, implementing driver settings in a vehicle or starting the vehicle engine. In some implementations, the electronic device 110 may operate as a wireless hotspot and allow the vehicle 130 to communicate with one or more servers 120 through the electronic device 110.

The one or more servers 120 may be any suitable computing device coupled to one or more networks, and may include, but are not limited to, a personal computer, a server computer, a series of server computers, a mini computer, and a mainframe computer, or combinations thereof. As an example, the one or more servers may include one or more vehicle manufacturer servers that communicate with one or more vehicles.

The one or more servers may implement common and standard protocols and libraries, such as the Secure Sockets Layer (SSL) protected file transfer protocol, the Secure Shell File Transfer Protocol (SFTP)-based key management, and the NaCl encryption library. The one or more servers may be used for and/or provide cloud and/or network computing. Although not shown in the figures, the one or more servers may have connections to external systems providing messaging functionality such as e-mail, SMS messaging, text messaging, and other functionalities, such as encryption/decryption services, cyber alerts, etc.

The one or more servers may be connected to or may be integrated with one or more databases. The one or more databases may include a cloud database or a database managed by a database management system (DBMS). In general, a cloud database may operate on platforms such as Python. A DBMS may be implemented as an engine that controls organization, storage, management, and retrieval of data in a database. DBMSs frequently provide the ability to query, backup and replicate, enforce rules, provide security, do computation, perform change and access logging, and automate optimization. A DBMS typically includes a modeling language, data structure, database query language, and transaction mechanism. The modeling language may be used to define the schema of each database in the DBMS, according to the database model, which may include a hierarchical model, network model, relational model, object model, or some other applicable known or convenient organization. Data structures can include fields, records, files, objects, and any other applicable known or convenient structures for storing data. A DBMS may also include metadata about the data that is stored. In some implementations, the databases may store content to be displayed using a display device in a vehicle.

The one or more networks may provide network access, data transport, and other services to the system, one or more network servers, and one or more databases. In general, the one or more networks may include and implement any commonly defined network architectures including those defined by standards bodies, such as the Global System for Mobile communication (GSM) Association, the Internet Engineering Task Force (IETF), and the Worldwide Interoperability for Microwave Access (WiMAX) forum. For example, the one or more networks may implement one or more of a GSM architecture, a General Packet Radio Service (GPRS) architecture, a Universal Mobile Telecommunications System (UMTS) architecture, and an evolution of UMTS referred to as Long Term Evolution (LTE). The one or more networks may implement a WiMAX architecture defined by the WiMAX forum or a Wireless Fidelity (WiFi) architecture. The one or more networks may include, for instance, a local area network (LAN), a wide area network (WAN), the Internet, a virtual LAN (VLAN), an enterprise LAN, a layer 3 virtual private network (VPN), an enterprise IP network, corporate network, or any combination thereof.

Vehicle 130 may be a transportation medium including, but not limited to, an automobile, motor cycle, truck, Segway, boat, and rickshaw. Vehicle 130 may be any suitable make and model including, for example, a Honda Civic, Honda Accord, Toyota Camry, Volkswagen Beetle, Mercedes Benz CLK, BMW 5 series, Chevrolet Corvette, etc. Vehicle 130 includes a display device configured to display information to a driver or passengers in vehicle 130, and various additional components, such as breaks, lights, gears, and a steering device.

Vehicle 130 also includes a vehicle control module, which may be a processor or computing device configured to execute operations in the vehicle 130 and obtains data regarding various components in the vehicle 130. For example, vehicle control module may be connected to devices such as sensors, lights, and wheels in the vehicle 130, and may receive information regarding these devices such as an operating status of these devices. The vehicle control module may also communicate with the electronic device 110 and one or more servers 120 to transmit and receive data.

The display device may include a screen 132 that displays content using any suitable display technology including, but not limited to, a liquid crystal display (LCD), a light emitting diode (LED) display, an organic LED (OLED) display. The screen 132 may include a touch display to receive touch inputs through screen 132. In general, screen 132 may utilize one or more touchscreen technologies to implement the touch display. For example, screen 132 may utilize one or more of resistive, capacitive, infrared, optical, dispersive signal, and acoustic pulse recognition technologies to implement a touchscreen graphical user interface.

Screen 132 is configured to display various types of information to a user. The information may be organized and displayed in various suitable manners. For example, in some implementations, as shown in FIG. 1A, screen 132 may display a list of information, such as a playlist. The playlist may include a list of items, e.g., list items 1-8, and buttons 134A, 134B, 136A, 136B.

In general, a user may refer to the driver or any passenger of vehicle 130. The user may utilize a finger 140 or other input devices, such as a stylus, to interact with the screen 132 and browse through the list of information. For example, a user may select button 134A using finger 140 to request the vehicle 130 to display a portion (e.g., page) of information that precedes the information being displayed on screen 132. A user may select button 134B using finger 140 to request the vehicle 130 to display a portion (e.g., page) of information that succeeds the information being displayed on screen 132. A user may select button 136A using finger 140 to request the vehicle 130 to scroll the information upward or display a list item that immediately succeeds the information being displayed on screen 132. A user may select button 136B using finger 140 to request the vehicle display to scroll the information downward or display a list item that immediately precedes the information being displayed on screen 132. Buttons 134A, 134B, 136A, and 136B are not limited to the shape, size, or location shown in FIG. 1A, and may be implemented using various representations and in different locations of screen 132.

According to implementations, the user may also navigate through the list without using buttons 134A, 134B, 136A, 136B. For example, the user may perform a touch and drag action by touching the user's finger 140 on the screen 132 and dragging the finger along the screen 132. A vehicle control module in vehicle 130 may determine a direction, distance, and velocity of the touch and drag action and execute one or more operations. In particular, if the touch and drag action has a distance or velocity that satisfies a maximum distance threshold or maximum velocity threshold, the vehicle control module executes a page transition operation and commands the display device to display a preceding or succeeding page when the touch and drag action is in a downward or upward direction, respectively. If the touch and drag action satisfies a minimum distance threshold or minimum velocity threshold but fails to satisfy the maximum distance threshold and maximum velocity threshold, the vehicle control module executes a scrolling command.

By utilizing velocity and distance thresholds, information is prevented from moving in a random and unpredictable manner. In particular, by controlling the amount a list can move and executing page transitions once maximum velocity or maximum distance thresholds are satisfied, the user is unlikely to miss information and can more precisely and predictably navigate through the list of information. This is particular advantageous if the user is a driver of a vehicle.

Referring to FIG. 1B, screen 132 may display one or more list items in the list of information 180. The list items may include data content or provide a link to data content, and may be represented by various graphical representations. For example, the list items in the list of information 180 may have different shapes, sizes, and icons, and may be arranged in any particular order, such as an alphabetical order, chronological order, or numeric order.

Screen 132 may be divided in a visible area 160 and a non-visible area 150. One or more list items in the list of information 180 that are located in the visible area 160 are visible to a user. The non-visible area 150 may display additional information not included in the list of information 180 such as banners, advertisements, or notifications. The non-visible area 150 may be implemented as a layer over a portion of the visible area 160 thereby obscuring the list item underneath the non-visible area 150. For example, information displayed in a non-visible area 150 may cover or overlap information in the portion of the visible area 160 that the non-visible area 150 overlaps with. The non-visible area 150 may be implemented periodically, temporarily, or upon receiving one or more instructions by the vehicle control module or user. Accordingly, the screen 132 may, at times, include a non-visible area 150, and, at other times, may not include a non-visible area 150.

The list items in the list of information 180 are displayed on screen 132 at different times. The visible area 160 may display one set of list items in a page having a size of the visible area 160. The page may have boundaries set by the dimensions of the visible area 160, as shown in FIG. 1B. For example, a visible area 160 may have boundaries at a top or bottom portion where list items in the list of information 180 move onto or off the screen 132. In some implementations, the boundaries may also determine the positions of one or more anchors. For example, an anchor may be placed along the top border of the visible area 160 or at the list item that is situated along the top border of the visible area 160 but is not, completely or partially, displayed within the visible area 160. Another anchor may be placed along the bottom border of the visible area 160 or at the list item that is situated along the bottom border of the visible area 160 but is not, completely or partially, displayed within the visible area 160. The placement of the anchors may be adjusted dynamically based on the list items in the visible area 160 and the contents of the list of information 180. In some implementations, as described in more detail below, the list of information 180 is divided into a number of equal sized pages and each page may be allocated an anchor.

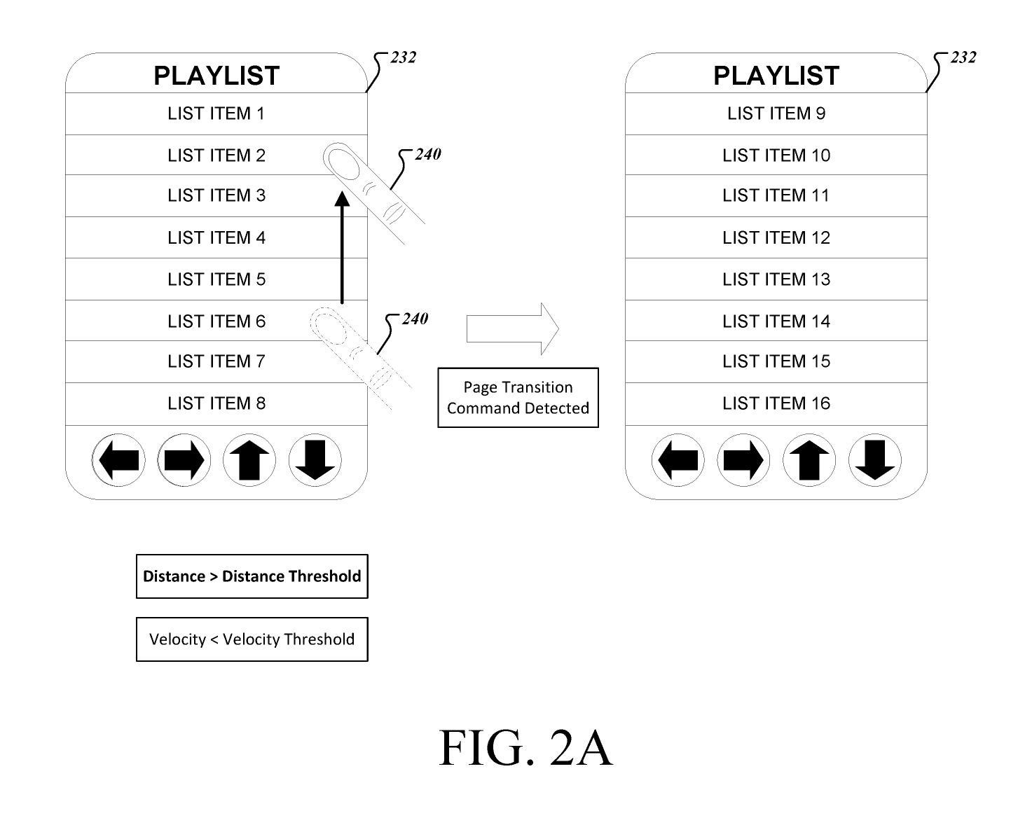

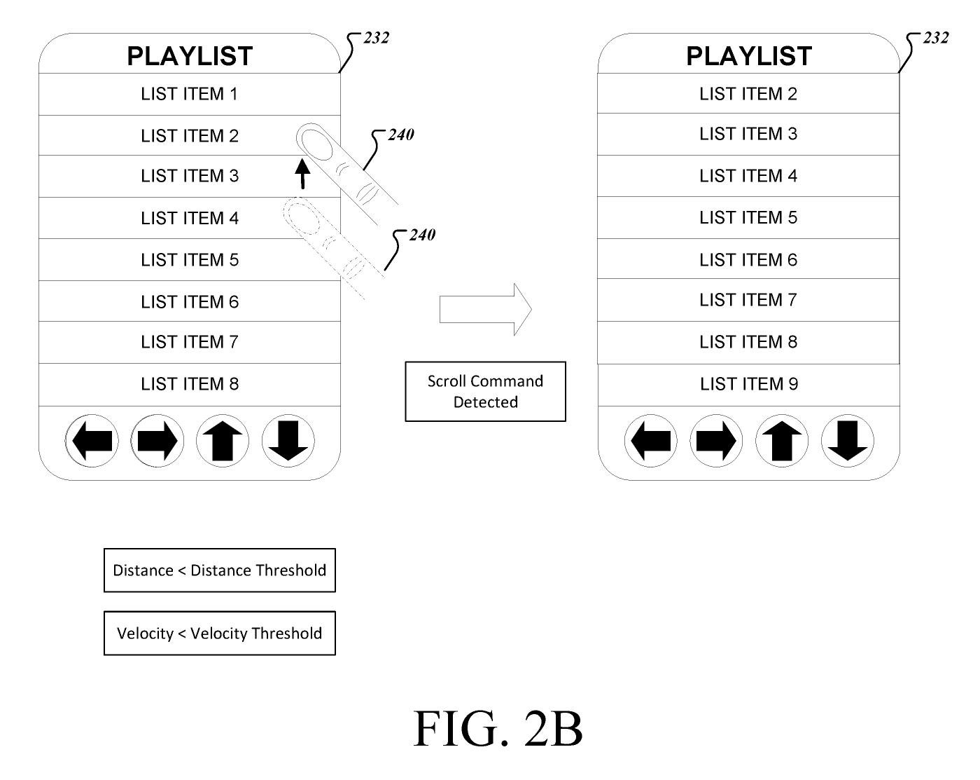

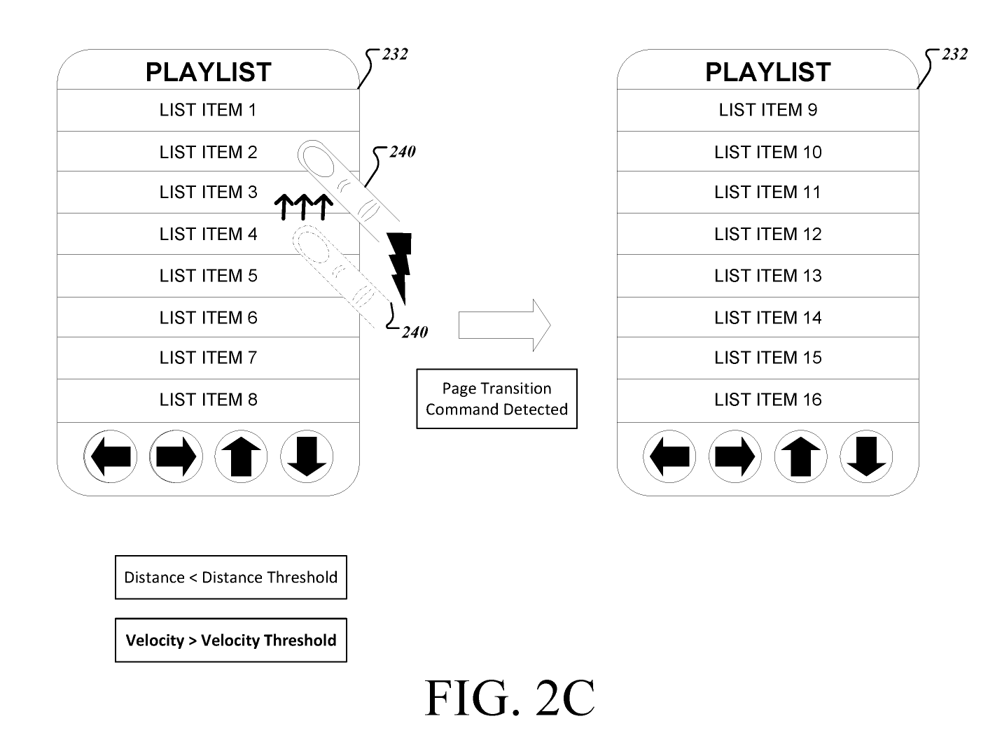

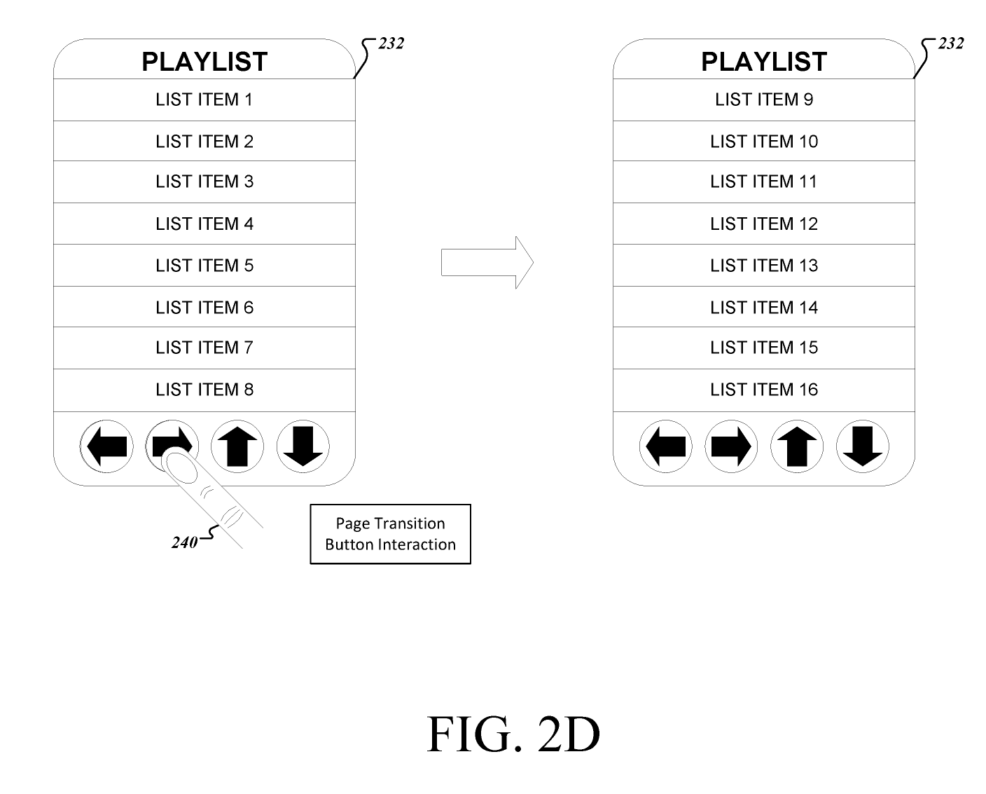

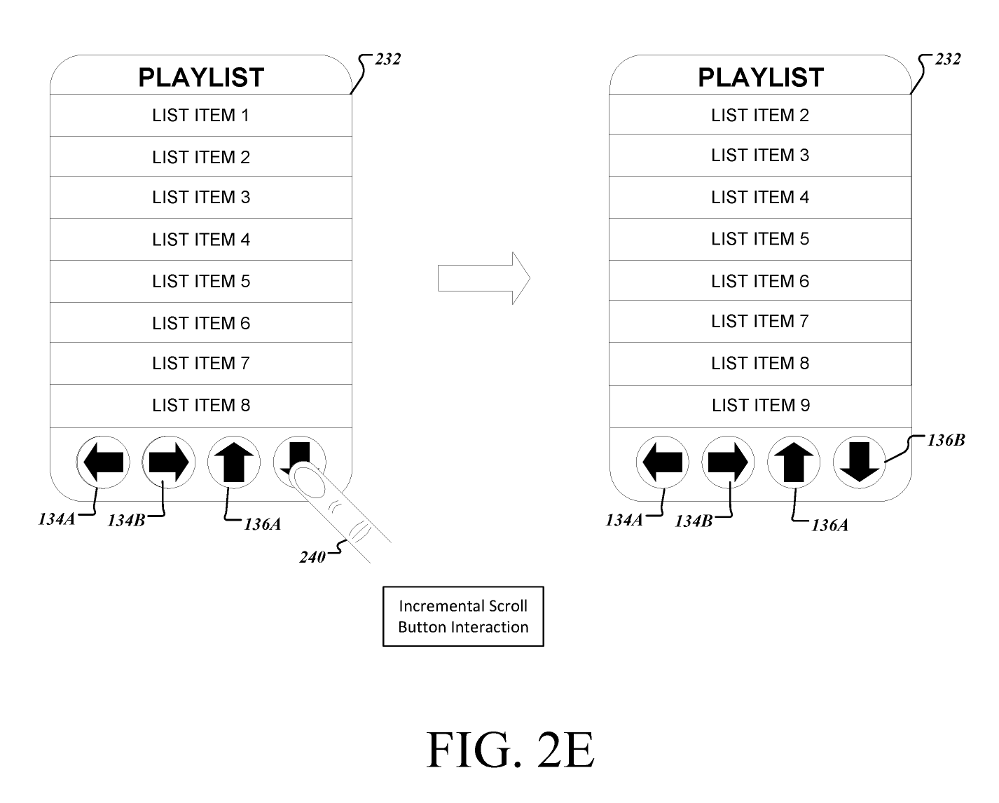

As noted above, implementations described herein provide methods and systems for improved control and precision of user interface navigation. FIGS. 2A-2E depict exemplary scenarios in which hybrid scrolling methods and systems are implemented.

Referring to FIG. 2A, a screen 232 displays list items 1-8. A user is interested in viewing the next set of list items, namely list items 9-16. The user utilizes the user's finger 240 and inputs a gesture, such as a touch and drag action. For example, as shown in FIG. 2A, the user moves the user's finger 240 in a touch and drag input action across the screen 232 in an upward vertical direction.

Screen 232 detects the user input and transmits a signal to the vehicle control module with information regarding the user input. In particular, screen 232 may provide the vehicle control module with information regarding a number of pixels corresponding to the portion of screen 232 that were touched by the user's finger in the touch and drag input action. The vehicle control module may determine whether the number of pixels or pixel distance corresponding to the user's touch and drag input satisfies a maximum distance threshold.

If the pixel distance is equal to or greater than a maximum distance threshold, the vehicle control module determines that the user input corresponds to a page transition command to obtain the next set of list items. The vehicle control module then obtains the next set of list items and displays the next set of list items on screen 232. The next set of list items corresponds to (i) a list of items that succeeds the set of list items displayed on the screen at the time of the user input, and (ii) a list of items that includes items can be displayed on the screen 232 at the same time.

If, as shown in FIG. 2B, the pixel distance corresponding to the user's touch and drag input action is less than a maximum distance threshold, the vehicle control module may determine that the user input corresponds to a scrolling command. The vehicle control module then obtains the next list item, displays the next list item on screen 232, and removes, from the screen 232, one list item from the top of the list. For example, as shown in FIG. 2B, list items 1-8 were displayed prior to receiving the user input, and list items 2-9 are displayed after receiving the user input.

In some implementations, the vehicle control module also determines whether the pixel distance corresponding to the user's touch and drag input satisfies a minimum distance threshold. If the user's touch and drag input has a pixel distance that does not equal or exceed the minimum distance threshold, the vehicle control module may determine that the user's touch and drag input was accidental and subsequently the vehicle control module takes no action. If the pixel distance corresponding to the user's touch and drag input equals or exceeds the minimum distance threshold, the vehicle control module determines whether the pixel distance satisfies the maximum distance threshold, as described above.

Referring to FIG. 2C, a screen 232 displays list items 1-8. A user utilizes the user's finger 240 and inputs a touch and drag input. For example, as shown in FIG. 2C, the user moves the user's finger 240 in a touch and drag input action across the screen 232 in an upward vertical direction.

Screen 232 detects the user input and transmits a signal to the vehicle control module with information regarding the user input. In particular, screen 232 may provide the vehicle control module with information regarding the pixel distance corresponding to the user's touch and drag input, and a time duration of the touch and drag input. Based on the pixel distance and timing information, the vehicle control module may determine whether the user's touch and drag input satisfies a maximum velocity threshold.

If the user's touch and drag input has a velocity that is equal to or greater than a maximum velocity threshold, the vehicle control module determines that the user input corresponds to a page transition command to obtain the next set of list items 9-16. The vehicle control module then obtains the next set of list items 9-16 and displays the next set of list items 9-16 on screen 232.

If the user's touch and drag input action has a velocity that is less than a maximum velocity threshold, the vehicle control module determines that the user input corresponds to a scrolling command. The vehicle control module then obtains the next list item, e.g., item 9, displays the next list item on screen 232, and removes, from the screen 232, one list item, e.g., item 1, from the top of the list.

In some implementations, the vehicle control module also determines whether the user's touch and drag input has a velocity that satisfies a minimum velocity threshold. If the velocity corresponding to the user's touch and drag input does not equal or exceed the minimum velocity threshold, the vehicle control module determines that the user's touch and drag input was accidental and therefore takes no action. If the velocity corresponding to the user's touch and drag input equals or exceeds the minimum velocity threshold, the vehicle control module determines whether the user's touch and drag input satisfies the maximum velocity threshold, as described above.

In some implementations, a user may utilize buttons 234A, 234B, 236A, and 236B to navigate through a list of information. In particular, buttons 234A and 234B may be utilized to execute page transition commands, and buttons 236A and 236B may be utilized to execute scroll commands. For example, as shown in FIG. 2D, a user may select button 234B to request the next set of list items after list items 1-8. In response to detecting the user selection of button 234B, the vehicle control module determines that a page transition command to transition to the succeeding set of list items has been received. The vehicle control module then obtains the next set of list items and provides instructions to screen 232 to display list items 9-16.

Referring to FIG. 2E, a user may select button 236B to request the next list item after list item 8. In response to detecting the user selection of button 236B, the vehicle control module determines that a scrolling command to scroll to the succeeding list item has been received. The vehicle control module then obtains the next list item and provides instructions to screen 232 to display list items 2-9 and remove list item 1.

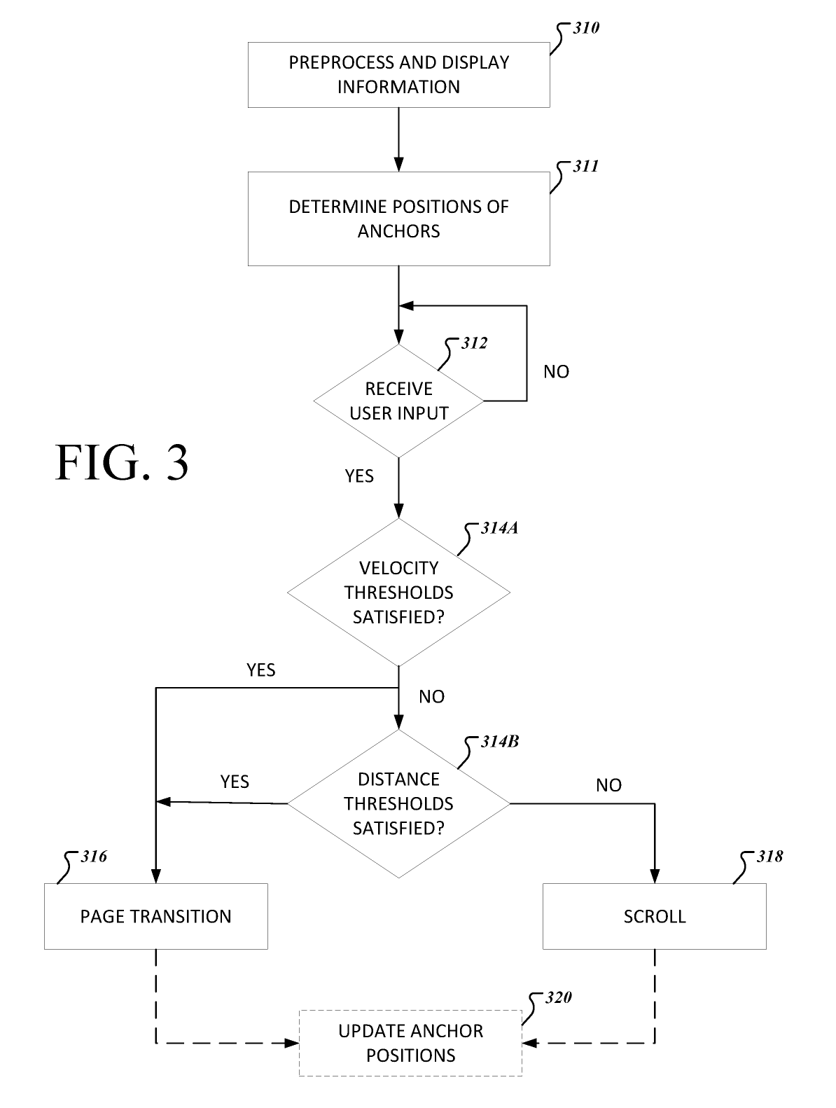

FIG. 3 illustrates methods for provisioning hybrid scrolling as illustrated in the scenarios depicted in FIGS. 2A-2E. The operations noted in the flowchart of FIG. 3 may be executed by one or more components in a vehicle such as the vehicle control module and display in the vehicle.

Referring to FIG. 3, a vehicle control module may preprocess and display information on a display screen in the vehicle (310). Preprocessing may include obtaining data content from one or more databases and networks, arranging the data content according to a display format of the display screen, and ordering the content according to a particular order. In general, various types of data content may be obtained. Examples of data content include, but are not limited to, map navigation content, weather content, and media content.

The vehicle control module may arrange data content for display on the display screen based on the type of content, the type of display screen, and any restrictions set by vehicle manufacturers. For example, the vehicle control module may prevent the display screen from displaying Internet video and gaming content based on restrictions set by vehicle manufacturers. The vehicle control module may identify the type of content, for example, a playlist or a user contacts list, being displayed by retrieving metadata and tags describing the content, and obtain information indicating how the content is to be displayed, for example, using text, icons, images, or other suitable display mediums. The vehicle control module may also obtain information regarding the screen, such as a size and resolution of the screen, information regarding graphical representations of the content, and determine how much content may be displayed on the screen at one time or one page.

In addition, the vehicle control module may obtain information about user preferences, application settings, display settings, and display the obtained data content according to the obtained information. For example, if an application setting is to display a list of information in alphabetical order, the vehicle control module will arrange the data content in an alphabetical list. If a user preference is to display content in a textual format, the vehicle control module may display the items in the list in a textual format. Based on various factors described above, the vehicle control module may preprocess and display information on a display screen in the vehicle (310).

The vehicle control module may also determine the positions of anchors according to an anchor-based page transition method or a relative page transition method (311). In the anchor-based page transition method, after obtaining data content from a database or network, the vehicle control module generates a list of items corresponding to the obtained data, and divides the list into pages. Each page includes graphical representations of one or more list items and includes content that can be displayed on a single screen of the display screen. The vehicle control module may determine a size of the graphical representations of the items on the list, and the graphical representations that can fit onto each page.

The vehicle control module may then allocate an anchor to each page. The anchor may be applied at the same location to each page. Anchors may be applied to a beginning, a middle, an end, or, in general, any location of a page. The vehicle control module may store information indicative of the order or the locations of the anchors in a database. In some implementations of the anchor-based page transition method, all representations of the list items are the same size.

In the relative page transition method, anchors are not assigned to each page. Instead, the vehicle control module may determine anchors for portions of the list that that immediately precede or succeed the displayed list items. In particular, the vehicle control module may determine a size of the graphical representations of the list items immediately preceding or succeeding the displayed list items, and the graphical representations that can fit on a page of list items immediately preceding or succeeding the page of list items being displayed on the display device. The vehicle control module may then configure the preceding and succeeding pages with the representations that fit onto the pages and assign a first anchor to the preceding page and a second anchor to the succeeding page. As an example, if a displayed list arranged in numerical order includes items 11-20, the vehicle control module may allocate a first anchor to a set of items corresponding to items 1-10, and a second anchor to a set of items corresponding to items 21-30. In some implementations, the vehicle control module may store the location of the anchors, such as the first anchor and the second anchor, and cache the content to be displayed on the preceding and succeeding pages.

In some implementations, for example, when a non-visible area is displayed, if a graphical representation of a list item is only partially displayed, an anchor may be allocated to the list item so that any transition from a currently displayed set of list items to the next set of list items will include a display of the complete graphical representation of the list item. If the partially viewable list item is at the end of the displayed list of information, the succeeding page of displayable content will include a list of information beginning with the partially viewable list item. If the partially viewable list item is at the beginning of the displayed list of information, the preceding page of displayable content will include a list of information ending with the partially viewable list item.

For example, if a displayed list arranged in numerical order includes items 11-20 but item 20 is only partially viewable, an anchor may be allocated to a page that includes item 20 on the top of the list, for example, a page including list items 20-29. In another example, if a displayed list arranged in numerical order includes items 11-20 but item 11 is only partially viewable, an anchor may be allocated to a page that includes item 11 at the bottom of the list, for example, a page including list items 2-11.

After determining the positions of anchors according to an anchor-based page transition method or a relative page transition method (311), the vehicle control module determines whether a user input has been received (312). The user input may include a touch by the user's finger, a touch by an input device, such as a stylus, or, in general, any user controlled touch on the screen of the vehicle. The user input may include various types of touches including, but not limited to, a touch and drag input, a two touch input including a first touch to indicate a starting point of a length to move the list and a second touch to indicate an ending point of the length to move the list.

As noted above, various techniques may be utilized to detect and process a user input. For example, capacitive or resistive sensing may be used to determine whether a user input has occurred. The vehicle control module may also obtain additional data from the display screen regarding the user input including, for example, data indicating a number of pixels that were contacted during the user input, a pixel distance or distance in any measurable unit corresponding to the user's input, and a time duration of the user input. In some implementations in which capacitive sensing is utilized to detect user input, the capacitive sensors may determine a location at which the user's touch is initiated, a number of pixels that the user input traverses, and a location at which the user's touch terminates. The vehicle control module may also initiate a counter when a user touch is initiated and continue the counter until the user touch is terminated to determine a time duration of the user input.

If no user input is received, the vehicle control module takes no further action and waits for user input to be received. If user input is received, the vehicle control module obtains data corresponding to the user input and determines whether one or more of velocity thresholds and distance thresholds are satisfied (314A, 314B).

In some implementations, as described above, the vehicle control module may determine whether the user input satisfies minimum distance or minimum velocity thresholds. For example, if a distance corresponding to the user input is less than the minimum distance threshold or if the velocity corresponding to the user input is less than the minimum velocity threshold, the vehicle control module determines that the user input was accidental. If the pixel distance corresponding to the user input equals or exceeds the minimum distance threshold or if the velocity corresponding to the user input equals or exceeds the minimum velocity threshold, the vehicle control module determines that a user input was received and determines whether one or more of a maximum velocity threshold and a maximum distance threshold is satisfied.

As shown in FIG. 3, the vehicle control module determines whether a velocity corresponding to the user input satisfies the maximum velocity threshold. If the user input satisfies the maximum velocity threshold, the vehicle control module determines that a page transition command was requested by the user and the vehicle control module executes a page transition command (316). If the user input does not satisfy the maximum velocity threshold, the vehicle control module determines whether a distance corresponding to the user input satisfies the maximum distance threshold. If the user input satisfies the maximum distance threshold, the vehicle control module determines that a page transition command was requested by the user and the vehicle control module executes a page transition command (316). If the user input does not satisfy the maximum distance threshold or the maximum velocity threshold, the vehicle control module determines that a scrolling command was requested by the user and executes a scrolling command (318).

The minimum distance threshold, maximum distance threshold, minimum velocity threshold, and maximum velocity threshold may be set by a manufacturer of the vehicle or a manufacturer of the display screen in the vehicle.

The page transition command is a command for the vehicle display screen to move to a succeeding or preceding anchor in the list of information and display a new page of list items. For example, as illustrated in FIG. 2A, if the user input satisfies a distance threshold by moving the user's finger in an upward direction across the screen, the vehicle control module may execute a page transition command (316) and control the display screen to display a new page of list items in the list of information allocated to a succeeding anchor. If the user input satisfies a distance threshold by moving the user's finger in a downward direction across the screen, the vehicle control module may execute a page transition command (316) and control the display screen to display a new page of list items in the list of information allocated to a preceding anchor. As described above, an anchor may be allocated to a page or portions of a list of information that have representations that can be displayed on a single display screen.

To execute the page transition command, the vehicle control module searches for an anchor preceding or succeeding an anchor associated with a displayed page, and after identifying the preceding or succeeding anchor, obtains the portion of the list of information associated with the identified anchor. The vehicle control module may then provide the obtained portion of the list of information to the display screen. For example, as shown in FIG. 2A, if a user input corresponding to a transition to a next page of the list of information is received, the vehicle control module searches and identifies an anchor associated with a page that immediately succeeds the displayed page. The vehicle control module then obtains the list items on the succeeding page, and provides the list items or page of list items to the display screen for display.

The vehicle control module may generate a scroll command and transmit instructions to the display screen to execute the scroll command (318). Upon receiving the instructions, the display screen may modify the contents displayed on the display screen consistent with a distance and direction of the user input. For example, if the distance corresponding to the user input is more than the minimum distance threshold, less than the maximum distance threshold, and equivalent to a particular distance, the vehicle control module will generate and transmit instructions to execute a scroll command to the display screen to scroll the list of information by an amount and direction equivalent to the distance and direction of the user input.

When anchors have been determined using the relative page transition method and after executing a scrolling or page transition command, the vehicle control module may determine the new anchor positions for the succeeding and preceding pages (320). The new or updated anchor positions may be determined in the same manner as operation 311 described above.

In some implementations, anchor positions may be set for each item in a list. When a user scrolls through a list, the system can end the scrolling motion so that the nearest anchor position is set at the top or bottom boundary of the display area for the list. Thus, the scrolling movement can settle or snap to a position in which the top item or bottom item is fully viewable.

In some implementations, scrolling is carried out using inertial scrolling, e.g., if a user is moving a list at speed and releases, the list should continue moving and gradually slow to a stop. The faster the movement, the farther the list scrolls in the direction of travel. This technique can be used up to the point that the velocity threshold is reached causing the input to be interpreted as a page transition command. For example, the page transition threshold can be set so that movements with a sufficient velocity to scroll all of the visible list items out of view, the device can instead detect and carry out a page transition that sets the appropriate page in view and stops motion of the list items.

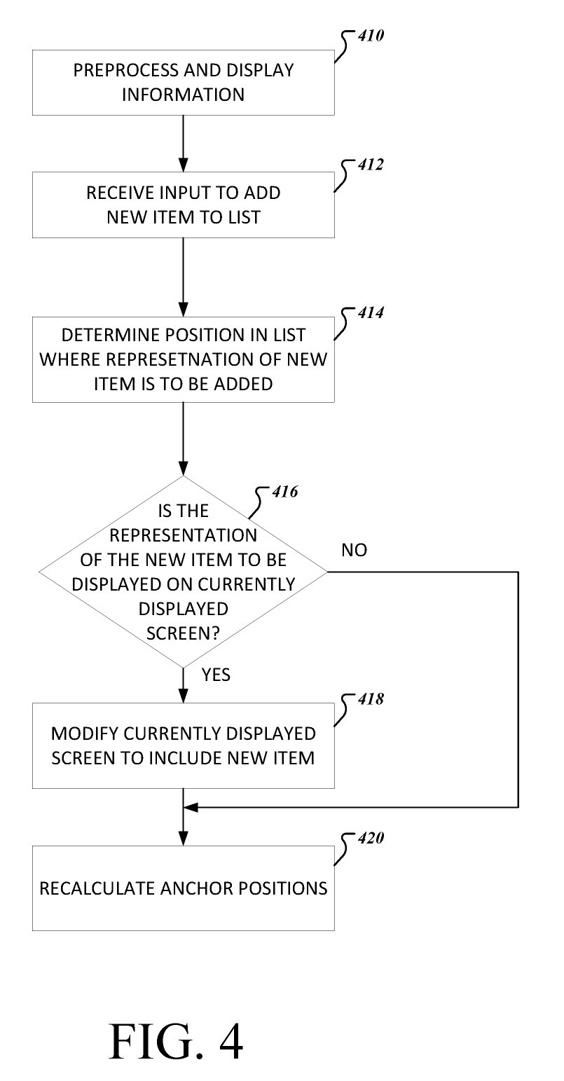

In addition to navigating through a list of information, a user may also be interested in adding list items to the list. FIG. 4 depicts a flowchart illustrating exemplary methods for inputting new data content. Initially, a vehicle control module may preprocess and display information on a display screen in the vehicle (410). Operation 410 may be performed in a similar manner as operation 310 described above.

The vehicle control module may then receive an input to add a new item to the list (412). The input to add a new item may be received as a user request or selection to add new content. For example, the user may elect to add a song or file to a media playlist being displayed by display screen.

After receiving the input, the vehicle control module determines a location in the list at which a representation of the new content is to be added (414). In some implementations, to determine the location in the list, the vehicle control module may determine an order in which the list of information is organized and a position in the list of information where the representation of the new list item is to be added according to the determined order.

After determining the location in the list of information at which a representation of the new list item is to be added (414), the vehicle control module may determine whether a representation of the new list item is to be added to the portion of the list being displayed (416). For example, the vehicle control module may determine whether the location at which the new list item is to be added is in a portion of the list that is being displayed by the display screen.

If the determined location at which the new list item is to be added is in a portion of the list that is being displayed, the vehicle control module may insert the new list item at the determined location and generate instructions for the display screen to update the displayed portion of the list with the new list item (418). If the representation of the new list item is not going to be added to a portion of the list of information that is being displayed, the vehicle control module may update the list of information by inserting the new list item into the list of information at the determined position without modifying the displayed portion of the list.

After updating the list with the new list item, the vehicle control module may determine new anchor positions for the list if the anchor-based page transition method is used to determine anchor positions (420). If the relative page transition method is used to determine anchor positions, the vehicle control module may determine new anchor positions when the new list item is to be added to a portion of the list being displayed or to a succeeding or preceding page.

Embodiments and all of the functional operations and/or actions described in this specification may be implemented in digital electronic circuitry, or in computer software, firmware, or hardware, including the structures disclosed in this specification and their structural equivalents, or in combinations of one or more of them. Embodiments may be implemented as one or more computer program products, for example, one or more modules of computer program instructions encoded on a computer readable medium for execution by, or to control the operation of, data processing apparatus. The computer-readable medium may be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, for example, code that constitutes processor firmware, a protocol stack, a database management system, an operating system, or a combination of one or more of them. A propagated signal is an artificially generated signal, for example, a machine-generated electrical, optical, or electromagnetic signal that is generated to encode information for transmission to a suitable receiver apparatus.

A computer program, also known as a program, software, software application, script, or code, may be written in any form of programming language, including compiled or interpreted languages, and it may be deployed in any form, including as a standalone program or as a module, component, subroutine, or other unit suitable for use in a computing environment. A computer program does not necessarily correspond to a file in a file system. A program may be stored in a portion of a file that holds other programs or data in a single file dedicated to the program in question, or in multiple coordinated files. A computer program may be deployed to be executed on one computer or on multiple computers that are located at one site or distributed across multiple sites and interconnected by a communication network.

The processes and logic flows described in this specification may be performed by one or more programmable processors, such as the vehicle control module, that executes one or more computer programs to perform actions by operating on input data and generating output. The processes and logic flows may also be performed by, and apparatus may also be implemented as, special purpose logic circuitry, for example, an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. A processor may include any suitable combination of hardware and software.

Elements of a computer may include a processor for performing instructions and one or more memory devices for storing instructions and data. Generally, a computer will also include, or be operatively coupled to receive data from or transfer data to, or both, one or more mass storage devices for storing data, for example, magnetic, magneto optical disks, or optical disks. Moreover, a computer may be embedded in another device, for example, a user device. Computer-readable media suitable for storing computer program instructions and data include all forms of non-volatile memory, media and memory devices, including by way of example semiconductor memory devices, for example, EPROM, EEPROM, and flash memory devices; magnetic disks, for example, internal hard disks or removable disks; magneto optical disks; and CD ROM and DVD-ROM disks. The processor and the memory may be supplemented by, or incorporated in, special purpose logic circuitry.

While this specification contains many specifics, these should not be construed as limitations on the scope of the disclosure or of what may be claimed, but rather as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and may even be claimed as such, one or more features from a claimed combination may in some cases be excised from the combination, and the claimed combination may be directed to a sub-combination or variation of a sub-combination.

Similarly, while actions are depicted in the drawings in a particular order, this should not be understood as requiring that such actions be performed in the particular order shown or in sequential order, or that all illustrated actions be performed, to achieve desirable results. Moreover, the separation of various system components in the embodiments described above should not be understood as requiring such separation in all embodiments, and it should be understood that the described program components and systems may generally be integrated together in a single software product or packaged into multiple software products.

It should be understood that the phrase one or more of and the phrase at least one of include any combination of elements. For example, the phrase one or more of A and B includes A, B, or both A and B. Similarly, the phrase at least one of A and B includes A, B, or both A and B.

Thus, particular implementations have been described. Other implementations are within the scope of the following claims. For example, the actions recited in the claims may be performed in a different order and still achieve desirable results.

What is claimed is:

1. A computer-implemented method comprising:
controlling, by one or more computing devices, a display device to display a first portion of a list on a graphical user interface;
receiving, by the one or more computing devices, a user input to the one or more computing devices;
determining, by the one or more computing devices, that the user input satisfies at least a distance threshold or a velocity threshold;
determining, by the one or more computing devices, that the user input corresponds to a page transition command based on determining that the user input satisfies at least the distance threshold or the velocity threshold; and
in response to determining that the user input corresponds to the page transition command, controlling, by the one or more computing devices, the display device to display a second portion of the list such that (i) list items fully viewable in the first portion of the list are not shown on the graphical user interface, and (ii) list items ordered immediately before or immediately after the first portion of the list are shown on the graphical user interface.

2. The computer-implemented method of claim 1, wherein determining that the user input corresponds to the page transition command comprises:
selecting between (i) classifying the user input as an incremental scroll command and (ii) classifying the user input as a page transition command, wherein the selection is made based on whether the user input satisfies at least the distance threshold or the velocity threshold.

3. The computer-implemented method of claim 1, further comprising:
receiving a second user input;
determining that the second user input does not satisfy the distance threshold and does not satisfy the velocity threshold; and
in response to determining that the user input does not satisfy the distance threshold and does not satisfy the velocity threshold, determining that the second user input corresponds to a scrolling command that does not involve a page transition.

4. The computer-implemented method of claim 1, further comprising:
determining an anchor position in the list corresponding to a particular item in the list that immediately follows a last list item that is fully viewable in the first portion of the list; and
determining that the user input requests a portion of the list after the first portion of the list;
wherein controlling the display device to display the second portion of the list comprises:
controlling the display device to display a portion of the list that begins at the determined anchor position; and
controlling the display device to display the particular item in the list at the beginning of the displayed portion of the list that begins at the determined anchor position.

5. The computer-implemented method of claim 1, further comprising:
determining an anchor position in the list corresponding to a particular item in the list that occurs immediately before the list items in the first portion of the list, wherein the particular item is selected such that when the particular item is the first list item shown in a list view area of the user interface, a list item fully viewable in the list view area is a list item that occurs immediately before the first list item fully viewable in the first portion of the list; and
determining that the user input requests a portion of the list before the first portion of the list;
wherein controlling the display device to display the second portion of the list comprises:
controlling the display device to display a portion of the list that begins at the determined anchor position; and
controlling the display device to display the particular item in the list at the beginning of the displayed portion of the list that begins at the determined anchor position.

6. The computer-implemented method of claim 1, wherein two or more items in the list have different sizes, and wherein views of different portions of the list shown in response to page transitions commands include different numbers of list items.

7. The computer-implemented method of claim 1, further comprising:
determining, by the one or more computing devices:
a position of a first anchor that corresponds to (I) a position on the list that immediately precedes the first portion of the list being displayed by the display device, and (II) a portion of the list immediately preceding the first portion of the list being displayed by the display device; and
a position of a second anchor that corresponds to (I) a position on the list that immediately follows the first portion of the list being displayed by the display device, and (II) a portion of the list immediately following the first portion of the list being displayed by the display device; and
wherein controlling the display device to display the second portion of the list comprises controlling the display device to display a view of the list using the first anchor or the second anchor.

8. The computer-implemented method of claim 7, further comprising:
determining, by the one or more computing devices:
a modified position of the first anchor that corresponds to (I) a position on the list that immediately precedes the second portion of the list being displayed by the display device, and (II) a portion of the list immediately preceding the second portion of the list; and
a modified position of the second anchor that corresponds to (I) a position on the list that immediately follows the second portion of the list being displayed by the display device, and (II) a portion of the list immediately following the second portion of the list.

9. The computer-implemented method of claim 1, further comprising:
determining an order for the items in the list;
determining a size of graphical representations of the items in the list;
determining, based on the order for the items and the size of the graphical representations, a set of the graphical representations that configure a page immediately preceding the first portion of the list displayed on the display device before receiving the user input; and
setting an anchor position in the list corresponding to a boundary of the page immediately preceding the first portion.

10. The computer-implemented method of claim 1, wherein determining a position of the second anchor comprises:
determining an order for the items on the list;
determining a size of the graphical representations of the items in the list;
determining, based on the order for the items and the size of the graphical representations, a set of the graphical representations that configure a page immediately following the first portion of the list displayed on the display device before receiving the user input; and
setting an anchor position in the list corresponding to a boundary of the page immediately following the first portion.

11. The computer-implemented method of claim 1, wherein graphical representations for the items in the list each have a same size.

12. The computer-implemented method of claim 1, wherein the display device is a display device in a vehicle, wherein the method further comprises:
obtaining the list to be displayed through the display device in the vehicle using the graphical user interface;
organizing the list into pages based on a size of the display device in the vehicle; and
determining, by the one or more computing devices, one or more anchors to be applied to the list, each of the one or more anchors respectively corresponding to (i) a position on the list, and (ii) a particular page.

13. The computer-implemented method of claim 12, wherein organizing the list into pages comprises:
determining an order for the data content items on the list;
determining a size of graphical representations for each list item in the list; and
determining a number of graphical representations of the list items per page.

14. The computer-implemented method of claim 1, further comprising:
determining that additional list items are to be added to the list;
determining a position in the list where the additional list items are to be added based on an order of items in the list;
adjusting the list to add the additional list items to the list at the determined position; and
determining, based on the adjusted list, positions of (i) a first anchor corresponding to a page immediately preceding the first portion of the list, and (ii) a second anchor corresponding to a page immediately following the first portion of the list.

15. The computer-implemented method of claim 1, wherein determining, by the one or more computing devices, whether the user input satisfies at least a distance threshold or a velocity threshold comprises:
determining whether the user input satisfies the distance threshold, and in response to determining that the user input does not satisfy the distance threshold, determining whether the user input satisfies the velocity threshold; or
determining whether the user input satisfies the velocity threshold, and in response to determining that the user input does not satisfy the velocity threshold, determining whether the user input satisfies the distance threshold.

16. The computer-implemented method of claim 1, wherein controlling the display device to display the second portion of the list comprises:
searching for a second anchor that immediately precedes or follows a first anchor associated with the first portion of the list; and
obtaining a page of the list associated with the second anchor.

17. A system comprising:
one or more computing devices and one or more storage devices storing instructions that, when executed by the one or more computing devices, cause the one or more computing devices to perform operations comprising:
controlling a display device to display a first portion of a list on a graphical user interface;
receiving a user input to the one or more computing devices;
determining that the user input satisfies at least a distance threshold or a velocity threshold;
determining that the user input corresponds to a page transition command based on determining that the user input satisfies at least the distance threshold or the velocity threshold; and
in response to determining that the user input corresponds to the page transition command, controlling the display device to display a second portion of the list such that (i) list items fully viewable in the first portion of the list are not shown on the graphical user interface, and (ii) list items ordered immediately before or immediately after the first portion of the list are shown on the graphical user interface.

18. The system of claim 17, wherein:
the operations further comprise:
determining a position of a first anchor that corresponds to (I) a position on the list that immediately precedes the first portion of the list being displayed by the display device, and (II) a portion of the list immediately preceding the first portion of the list being displayed by the display device; and
determining a position of a second anchor that corresponds to (I) a position on the list that immediately follows the first portion of the list being displayed by the display device, and (II) a portion of the list immediately following the first portion of the list being displayed by the display device; and
controlling the display device to display the second portion of the list comprises controlling the display device to display a view of the list using the first anchor or the second anchor.

19. One or more non-transitory computer-readable media comprising instructions that, when executed by the one or more computing devices, cause the one or more computing devices to perform operations comprising:
controlling a display device to display a first portion of a list on a graphical user interface:
receiving a user input to the one or more computing devices;
determining that the user input satisfies at least a distance threshold or a velocity threshold;
determining that the user input corresponds to a page transition command based on determining that the user input satisfies at least the distance threshold or the velocity threshold; and
in response to determining that the user input corresponds to the page transition command, controlling the display device to display a second portion of the list such that (i) list items fully viewable in the first portion of the list are not shown on the graphical user interface, and (ii) list items ordered immediately before or immediately after the first portion of the list are shown on the graphical user interface.

20. The one or more non-transitory computer-readable media of claim 19, wherein:
the operations further comprise:
determining a position of a first anchor that corresponds to (I) a position on the list that immediately precedes the first portion of the list being displayed by the display device, and (II) a portion of the list immediately preceding the first portion of the list being displayed by the display device; and
determining a position of a second anchor that corresponds to (I) a position on the list that immediately follows the first portion of the list being displayed by the display device, and (II) a portion of the list immediately following the first portion of the list being displayed by the display device; and
controlling the display device to display the second portion of the list comprises controlling the display device to display a view of the list using the first anchor or the second anchor.
